(19) United States
(12) Patent Application Publication
(10) Pub. No.: US 2008/0022209 A1
(43) Pub. Date: Jan. 24, 2008

(54) DYNAMICALLY CONTROLLING CONTENT AND FLOW OF AN ELECTRONIC MEETING

(76) Inventor: Ruthie D. Lyle, Durham, NC (US)

Correspondence Address: HOFFMAN, WARNICK & D'ALESSANDRO LLC, 75 STATE ST, 14TH FLOOR, ALBANY, NY, 12207, US

(21) Appl. No.: 11/458,432

(22) Filed: Jul. 19, 2006

(51) Int. Cl. G06F 3/00

(52) U.S. Cl. 715/730; 715/751

(57) ABSTRACT

Dynamically controlling content and flow of an electronic meeting. After a meeting has been initiated, a monitoring system continuously monitors the meeting for an occurrence of a trigger event. The monitoring system determines whether a trigger event has occurred by comparing observed conditions to a set of predetermined trigger rules. A dynamic content controller receives notification from the monitoring system when a trigger event has occurred and then according to the applicable rules can impose a change to the content of the agenda and presentation and/or generate a visual indicator, which can then result in a change in the flow of the meeting or presentation.

### TECHNICAL FIELD

This disclosure relates generally to electronic meetings, and more specifically to a system, method and computer product that dynamically controls the content and flow of an agenda and presentations scheduled for an electronic meeting based on predetermined trigger event parameters.

### BACKGROUND

Electronic meetings systems are frequently employed to create predictable, repeatable patterns of collaboration among people working toward a goal. In a typical electronic meeting system scenario, each attendee has his or her own computer so that everyone can contribute to the same shared goal at the same time. This way, nobody needs to wait for a turn to communicate. Often, electronic meeting systems are used to conduct meetings to discuss certain topics of interest. Many of these meetings are run according to an agenda which provides a list of items to be discussed. A typical agenda will list the topics of discussion, the time allotted for each discussion item, the name of the presenter and possibly a link to the presentation which will be used to facilitate the discussion. When the meeting is initiated the content of the agenda and the presentations are displayed on an electronic meeting space viewable by the presenters and attendees.

During such a meeting, it is quite possible that not all attendees may be able to attend all of the presentations listed in the agenda or some may have only an interest in listening to specified items in the agenda. Therefore, the attendees will most likely rely on the schedule in the agenda to estimate when to log into the meeting or if already logged in, when to refocus their attention to the meeting to hear the desired presentation. As often happens, many meetings can get behind or even ahead of the schedule, and sometimes the schedule of presentation can be changed for unforeseen circumstances. All of these scenarios will render the agenda for the meeting practically ineffective to all participants. This makes it very difficult for attendees to join the meeting at the exact time that their presentation of interest is to begin without having to needlessly listen to other presentations that they do not have an interest in or possibly the time to hear.

Currently, there are no available tools that can note occurrences of events in a meeting that will change the timeliness of the agenda including presentations scheduled for discussion and pass that information onto attendees. If attendees of an electronic meeting knew that there was a change that affected the agenda and presentations scheduled in the agenda, then they could better plan when they could attend the meeting. A better scenario would be if after detecting an event that changed the agenda, there was an approach that could dynamically readjust the agenda and items for discussion and inform the attendees of the changes.

Therefore, there is a need for an methodology that can monitor an electronic meeting for the occurrences of events that will change the agenda of the meeting and the presentations scheduled for the meeting. In addition, there is a need for a methodology that can use the detection of an event to dynamically change the agenda and the associated presentations and that can present the revised information to all participants of the meeting; attendees, presenters and moderators. Providing a methodology that can control content of a meeting will allow attendees to better plan their schedules, presenters to better structure their presentations given time constraints and meeting attendance and moderators to do a better job of controlling the flow of the meeting.

### SUMMARY

In one embodiment, there is a method for dynamically controlling content and flow of a meeting including an agenda set for the meeting and presentations scheduled for the meeting. In this embodiment, the meeting including the agenda and presentations are continuously monitored for the occurrence of conditions that relate to one of a plurality of trigger event parameters. Then it is determined whether a trigger event has occurred during the meeting. The content and flow of the agenda and presentations are dynamically controlled when a trigger event has occurred.

In another embodiment, there is dynamic content controller tool for use in a computer system that manages a meeting including an agenda set for the meeting and presentations scheduled for the meeting. The tool comprises a trigger event rules repository configured to store a plurality of predetermined trigger rules. A monitoring system is configured to continuously monitor the meeting including the agenda and presentations for conditions set forth in the plurality of predetermined trigger rules. The monitoring system comprises logic that compares observed conditions to the plurality of predetermined trigger rules in the trigger event rules repository. A dynamic content controller is configured to receive notification from the monitoring system when a trigger event has occurred and impose a change to the content of the agenda and presentation that is in accordance with specifications set in the plurality of predetermined trigger rules.

In a third embodiment, there is a system for managing content and flow of a meeting including an agenda set for the meeting and presentations scheduled for the meeting. The system comprises an electronic meeting space configured to display contents of the agenda and presentation during the meeting. A trigger event rules repository is configured to store a plurality of predetermined trigger rules. A monitoring system is configured to continuously monitor the meeting displayed on the electronic meeting space for conditions set forth in the plurality of predetermined trigger rules. The monitoring system comprises logic that compares observed conditions to the plurality of predetermined trigger rules in the trigger event rules repository. A dynamic content controller is configured to receive notification from the monitoring system when a trigger event has occurred and impose a change to the content of the agenda and presentation that is in accordance with specifications set in the plurality of predetermined trigger rules. A visual indicator component is configured to generate visual indicators to the electronic meeting space, wherein the visual indicators are indicative of time expended and allotted for agenda items and presentations.

In a fourth embodiment, there is a computer-readable medium storing computer instructions for dynamically controlling content and flow of a meeting including an agenda set for the meeting and presentations scheduled for the meeting occurring within a computer system. The computer instructions comprise continuously monitoring the meeting including the agenda and presentations for the occurrence of conditions that relate to one of a plurality of trigger event parameters; determining whether a trigger event has occurred during the meeting; and dynamically controlling the content and flow of the agenda and presentations when a trigger event has occurred.

In yet another embodiment, there is a method for deploying a dynamic content controller tool for use in a computer system that manages a meeting including an agenda set for the meeting and presentations scheduled for the meeting. In this embodiment, a computer infrastructure is provided and is operable to continuously monitor the meeting including the agenda and presentations for the occurrence of conditions that relate to one of a plurality of trigger event parameters; determine whether a trigger event has occurred during the meeting; and dynamically control the content and flow of the agenda and presentations when a trigger event has occurred.

Therefore, this disclosure provides a method, system, and program product for deploying an application for using a dynamic content controller tool for use in a computer system that manages a meeting including an agenda set for the meeting and presentations scheduled for the meeting.

### BRIEF DESCRIPTION OF THE DRAWINGS

FIG. 1 shows a high-level component architecture diagram of a dynamic content controller tool in use with an electronic meeting system that can manage a meeting including an agenda set for the meeting and presentations scheduled for the meeting;

FIG. 2 shows an example of one visual indicator that is provided by the dynamic content controller tool shown in FIG. 1;

FIG. 3 is a flowchart describing some of the processing functions associated with using the dynamic content controller tool shown in FIG. 1 to generate user configurable content;

FIG. 4 is a flowchart describing some of the processing functions associated with using the dynamic content controller tool shown in FIG. 1 to control the content and flow of a meeting; and

FIG. 5 shows a schematic of an exemplary computing environment in which the dynamic content controller tool shown in FIG. 1 may operate.

### DETAILED DESCRIPTION

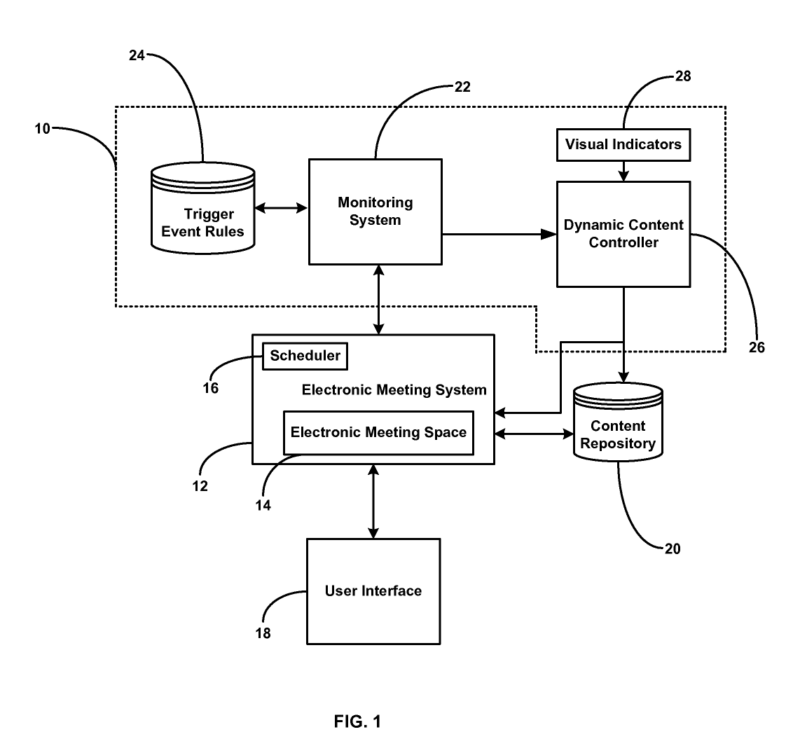

FIG. 1 shows a high-level component architecture diagram of a dynamic content controller tool 10 in use with an electronic meeting system 12 that can manage a meeting including an agenda set for the meeting and presentations scheduled for the meeting. Although the dynamic content controller tool 10 is described with reference to an electronic meeting system, it is suitable for use in other scenarios where meetings may be conducted and that rely on agendas and presentations to convey information to attendees. One of ordinary skill in the art will recognize that the principles of this disclosure are well suited for use in web conferencing, collaborative environments and even conventional presentations which rely on presentation programs to display information generally in the form of a slide show.

In an exemplary embodiment, the electronic meeting system 12 is a conventional electronic meeting system software package that provides an electronic meeting space 14 that hosts and displays information that is necessary for conducting a meeting such as the agenda and any presentations that are scheduled for the meeting. The electronic meeting system 12 also comprises a scheduler 16 that allows a moderator of the meeting to reserve a time to have a meeting and extend invitations to invitees through a calendar application.

Invitees who attend the meeting access the electronic meeting system 12 via a computing unit which can be a personal computer, workstation, notebook computer, or the like. The computing unit can access the electronic meeting system 12 and the dynamic content controller tool 10 via a communication network such as an electronic or wireless network. The communication network may be a private network such as an extranet or intranet or a global network such as a wide area network (e.g., Internet). In an exemplary embodiment, the electronic meeting system 12 and the dynamic content controller tool 10 reside in a server that serves these services to the attendees, presenters and moderators. However, the electronic meeting system 12 and the dynamic content controller tool 10 do not have to be co-resident with the server. The attendees, presenters and moderators use a user interface 18 to locate the electronic meeting system 12 so that they can view and participate in the meeting that is held on the electronic meeting space 14.

Also shown in FIG. 1 is a content repository 20 that is configured to store content that is used in the meeting by people such as the moderator of the meeting and the presenters. Generally, the content repository 20 will store the agenda scheduled for the meeting, the presentations which are expected to be presented in the meeting, and any other information that may be discussed by the moderator, presenters and attendees. The content repository 20 is not limited to storing any particular type of information or content in a particular format. It is within the scope of this disclosure that the content repository 20 stores content generated from a wide variety of software applications such as presentation, word processing, spreadsheet, database, and multimedia applications.

In an exemplary embodiment, the content when uploaded into the content repository 20 will contain time and content amount information. In particular, the time information comprises information such as the duration of a presentation, the time duration expected for a given slide in the presentation and the time expected for completion of the whole presentation taken at a slide. The content amount information comprises information such as the total number of slides or content to be presented, percentage of the presentation that has been completed taken at each slide with respect to the whole presentation. One of ordinary skill in the art will recognize that other forms of information can be appended to the content and that the scope of the invention is not limited to time and content amount information.

FIG. 1 shows that the dynamic content controller tool 10 comprises a monitoring system 22 configured to continuously monitor the meeting being conducted on the electronic meeting space 14 once it is initiated. This includes monitoring the agenda and presentations for the occurrence of conditions that relate to one of a plurality of trigger event parameters. As used herein, a trigger event is an occurrence of a condition that precipitates a change to the meeting and in particular, a change in the agenda and/or the presentations scheduled for the meeting. Trigger event parameters are thus variables that relate to the occurrence of trigger events.

In an exemplary embodiment, the trigger events parameters comprise attendance, time allotted and expended for agenda items and presentations and priority of content set for discussion in the meeting. For the attendance parameter, a trigger event can occur when attendance falls below a certain number of people, or if a certain number of the scheduled attendees have failed to register with the meeting session, or if there are users in attendance who are known to have a particular interest in only a few items scheduled for discussion in the meeting. In these examples, moderators of the meeting along with the presenters might want to use this attendance information to change the time allotted for certain presentations, or maybe even cancel specific presentations because of low interest from attendees. For the time parameter, a trigger event can occur when a presentation runs over the time allotted for that presentation or if the amount of time expended for the presentation is less than what was allotted. As a result, moderators and presenters can use this information to change the time allotted for other presentations, or maybe even cancel some presentations. For the priority of content parameter, a trigger event can occur when time is running out in the meeting and certain remaining items scheduled for discussion have a higher priority than others. As a result, the moderator or presenter can then skip certain sections and go directly to content that has a higher priority. One of ordinary skill in the art will recognize that these scenarios describing the trigger event parameters are only illustrative of examples and one of ordinary skill in the art will recognize that a multitude of other scenarios can be used to formulate a trigger event. Furthermore, one of ordinary skill in the art will recognize that other trigger event parameters are within the scope of this disclosure and it should not be limited to only attendance, time and content priority.

The monitoring system 22 comprises logic that compares observed conditions to a plurality of predetermined trigger rules stored in a trigger event rules repository 24. The trigger event rules repository 24 generally stores rules that provide guidelines on determining when a condition observed in a meeting is indicative of a trigger event. In addition to providing guidelines when a trigger event occurs, the trigger event rules also provide actions to be taken upon the occurrence of a trigger event.

Examples of some trigger event rules are as follows:
1. If all of the slides in a presentation have been completed before the allotted time then show a graphic denoting satisfaction or completion in the place of the status bar;
2. If 85% of the meeting attendees have left the presentation then end the presentation sooner or even cut out content. If specific content is of interest to specific invitees then cut out that portion;
3. If the time has expired before all of the slides have been shown then gently remind the moderator that he/she is running overtime using a graphic denoting impatience or caution together with a counter indicating the amount of time;
4. If all of the slides have been completed before the allotted time then automatically post a message to indicate that questions and answer will be taken for the duration of the allotted time; and
5. If the time has expired before all of the slides have been shown then pop up a timer to indicate that the presentation has exceeded the expected time duration. Using a predefined over time duration limit, allow the presentation to continue until this threshold has been met, then either stop the presentation.

### One of ordinary skill in the art will recognize that these examples of trigger event rules are only illustrative and non-exhaustive of the multitude of rules that could be implemented by one of ordinary skill in the art.

Referring back to FIG. 1, a dynamic content controller 26 is configured to receive notification from the monitoring system 22 when a trigger event has occurred. If specified in the trigger rules, the dynamic content controller 26 will impose a change to the content of the agenda and presentation. For example, if trigger rule two is invoked, then the dynamic content controller 26 could cut out content from a presentation if 85% of the meeting attendees left the presentation. Some other possible actions that the dynamic content controller 26 could perform on the content are adding content to the presentation if a certain subset or percentage of participants is present in the meeting.

In addition to imposing changes to the content, the dynamic content controller 26 also has the capability of providing visual indicators to the moderator, presenters and attendees via the electronic meeting space 14. As shown in FIG. 1, the visual indicators are generated in a visual indicators component 28 which is coupled to the dynamic content controller 26. Some examples of visual indicators include a graphic that denotes satisfaction or completion of a presentation or a certain item on the agenda of the meeting, a graphic denoting impatience or caution to the moderator or presenters that he or she is running overtime and a counter indicating the amount of time over, a message that indicates a question and answer period, a message to the presenter that he or she should skip a certain section of the presentation. One of ordinary skill in the art will recognize that these examples of visual indicators are only illustrative and non-exhaustive of the possibilities of indicators that could be generated.

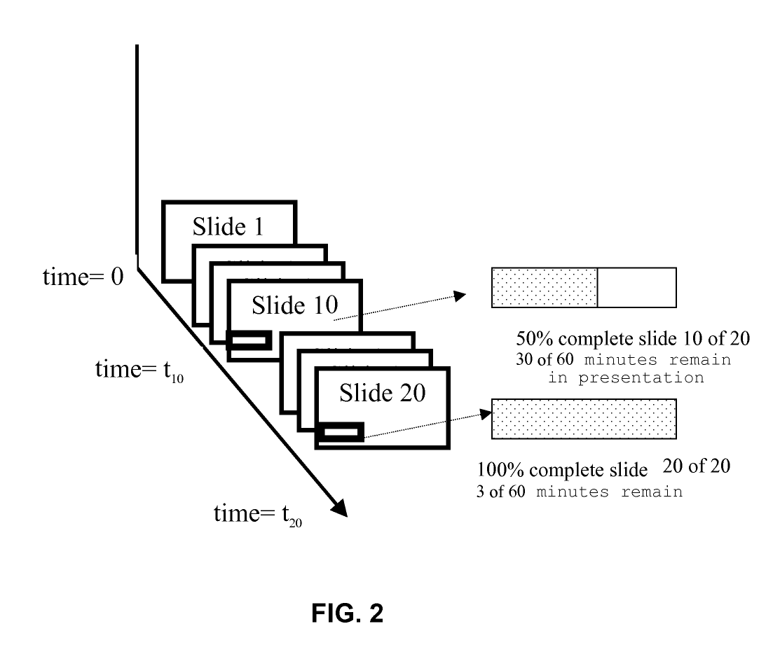

Generally, the dynamic content controller 26 will display a visual indicator on the electronic meeting space 14 once a meeting is initiated. FIG. 2 shows an example of one visual indicator that is provided by the dynamic content controller 26. The visual indicator denotes the progress being made in a presentation. As a slide show progresses the bar shown on the right hand side of the figure will fill to denote the amount of the presentation that has been completed. Similarly, if the presenter paged back, then the amount of filling in the bar would decrease so the exact location would be appropriately displayed. This indicator will allow attendees to be able to tell their place in the meeting as they join, determine the amount of content that they missed prior to joining the meeting and determine the rest of the content to be discussed for the remaining portion of the meeting. One of ordinary skill in the art will recognize that this example is illustrative of only one example of a visual indicator that can be used to denote progress. For example, this indication of the amount of content covered could be presented relative to the amount of meeting time remaining.

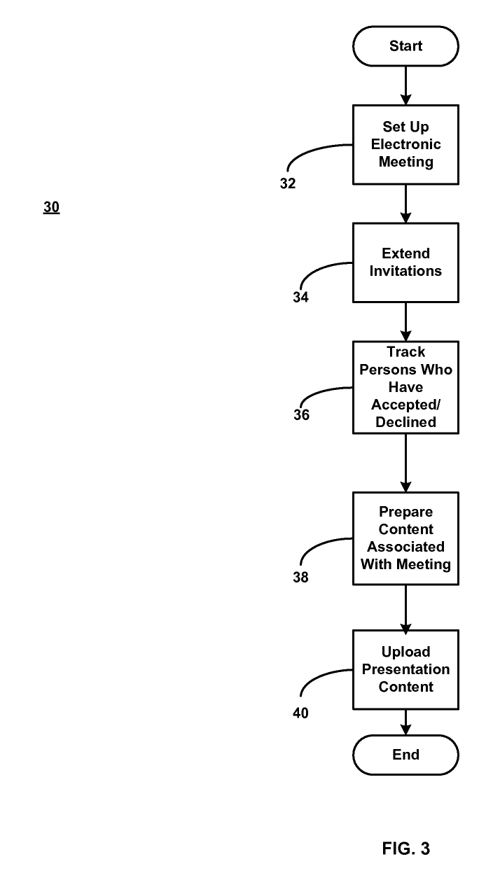

FIG. 3 is a flowchart 30 describing some of the processing functions associated with using the dynamic content controller tool 10 shown in FIG. 1 to generate user configurable content. At 32, a moderator sets up the electronic meeting. Generally, this includes opening a web browser for communicating with the electronic meeting system, entering a uniform resource locator (URL) for connecting to a server that provides the electronic meeting system, creating a link for the meeting, specifying a name for the electronic meeting space, and specifying invitees that are to be invited to the meeting along with any special privileges (e.g., presenters may have different privileges than attendees).

The scheduler will then extend electronic invitations to the specified attendees at 34 via a calendar application. Invitations are recorded and tracked at 36 to determine which invitees will attend the meeting and which attendees will not attend. This information is used later once a meeting is initiated to keep track of what time and/or point in the presentation that attendees join or leave a meeting.

At 38, presenters and moderators prepare the content for the meeting which would generally include the agenda and any presentations scheduled to be given in the meeting. The creator of each electronic presentation and agenda will specify user configurable information that associates with each item. For example, the creator could specify the total number of slides, the percentage of the presentation that has been completed taken at each slide with respect to the whole presentation, the expected time duration to complete the presentation, the time duration expected for a given slide in the presentation and the time expected for completion of the whole presentation taken at slide. After the content has been prepared, it is uploaded to the content repository at 40. As long as certain edit or modify privileges have been granted, creators can access the material in the content repository to make changes.

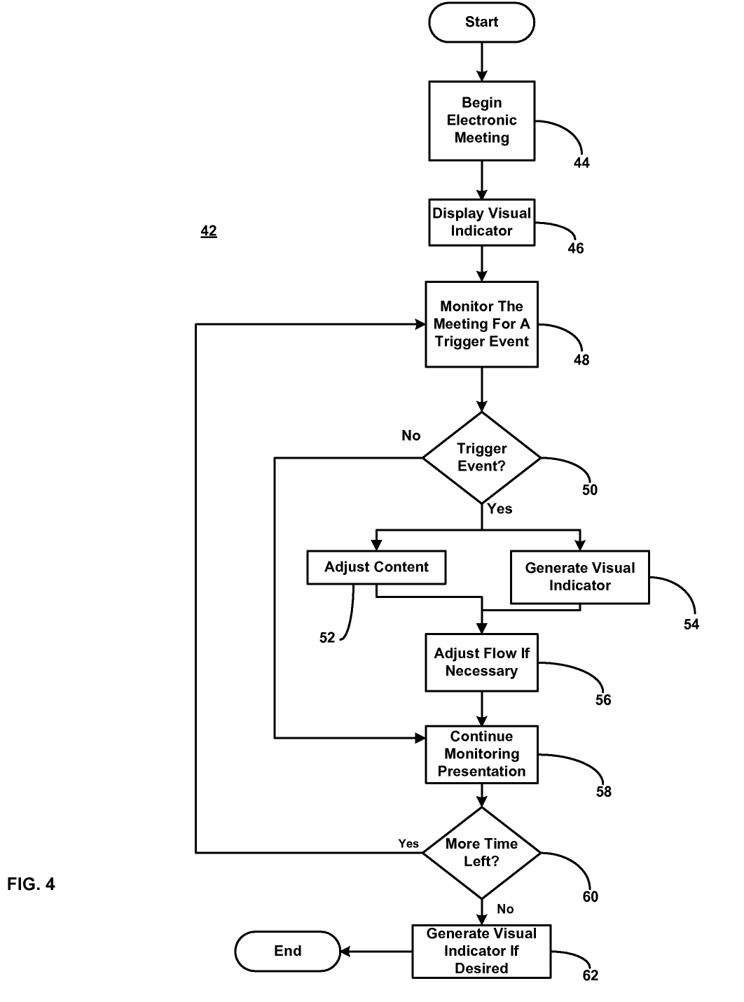

FIG. 4 is a flowchart 42 describing some of the processing functions associated with using the dynamic content controller tool shown in FIG. 1 to control the content and flow of an agenda including presentations scheduled for the meeting. At 44, the moderator initiates the electronic meeting. Once the meeting has been initiated, then any relevant visual indicators are displayed for the moderator, presenters and attendees at 46. As mentioned above, the visual indicator can take many forms and the context will depend on the situation. In an exemplary embodiment, once the meeting has been initiated then one indicator that will be displayed to the attendees is the point in time where the presentation is with respect to the whole material, as well as the meeting schedule and the time remaining to complete the presentation. Other indicators for the presenters and moderator are available which also will depend on the present situation. For example, the presenter and moderator might receive a message indicating that an invitee has joined the meeting. Also, to this regard, a record can be kept that indicates at one time and/or what point in the presentation that each attendee has joined the meeting. The moderator and/or presenter could then view the history of response to the electronic invitation and determine who is present, who is absent, who accepted, or who declined, who tentatively accepted, who are no shows, who provided no responses, etc. It is possible that this information could also be presented to the moderator in terms of statistics (e.g., percentage of accepted invitees that viewed the first half of the presentation, percentage of accepted invitees that consumed the entire presentation, who left the presentation and when or where).

During the meeting, the monitoring system will monitor the meeting for the occurrence of any trigger events at 48. In particular, the monitoring system compares observed conditions to the plurality of predetermined trigger rules stored in the trigger event rules repository. If the monitoring system determines that a trigger event has occurred at 50 then it will contact the dynamic content controller which will then adjust the content according to the rules at 52 and/or generate a visual indicator at 54. The flow of the presentation and/or meeting can be adjusted at 56 depending upon the actions dictated by the rules. For example, a portion of the presentation or meeting can be removed, rescheduled, and modified. Again this will depend on what actions are dictated by the rules. The adjustment of the content of the agenda and presentations and the adjustment of the flow of the meeting is dynamic because the dynamic content controller 26 is able to make these adjustments based on current conditions observed in the meeting and in particular, the occurrence of a trigger event.

If it is determined at 50 that there has been no occurrence of a trigger event then the monitoring system will continue to monitor the meeting at 58 for items such as who is in the meeting, how far along in the meeting is the presentation, what time it is, have any people dropped off, have more people logged onto the meeting, etc. At 60, a check is made to determine if there is still time left. If there is time remaining then the process repeats blocks 48 through 58 until it is determined that there is no more time left. If there is no time left, then a visual indicator can be generated at 62 that announces the end of the presentation or meeting. If the meeting or presentation is running over the allotted time then an indicator can be generated that notifies the presenter and/or moderator.

The foregoing flow charts show some of the processing functions associated with using the dynamic content controller tool 10. In this regard, each block represents a module, segment, or portion of code, which comprises one or more executable instructions for implementing the specified logical function(s). It should also be noted that in some alternative implementations, the functions noted in the blocks may occur out of the order noted in the figures or, for example, may in fact be executed substantially concurrently or in the reverse order, depending upon the functionality involved. Also, one of ordinary skill in the art will recognize that additional blocks may be added.

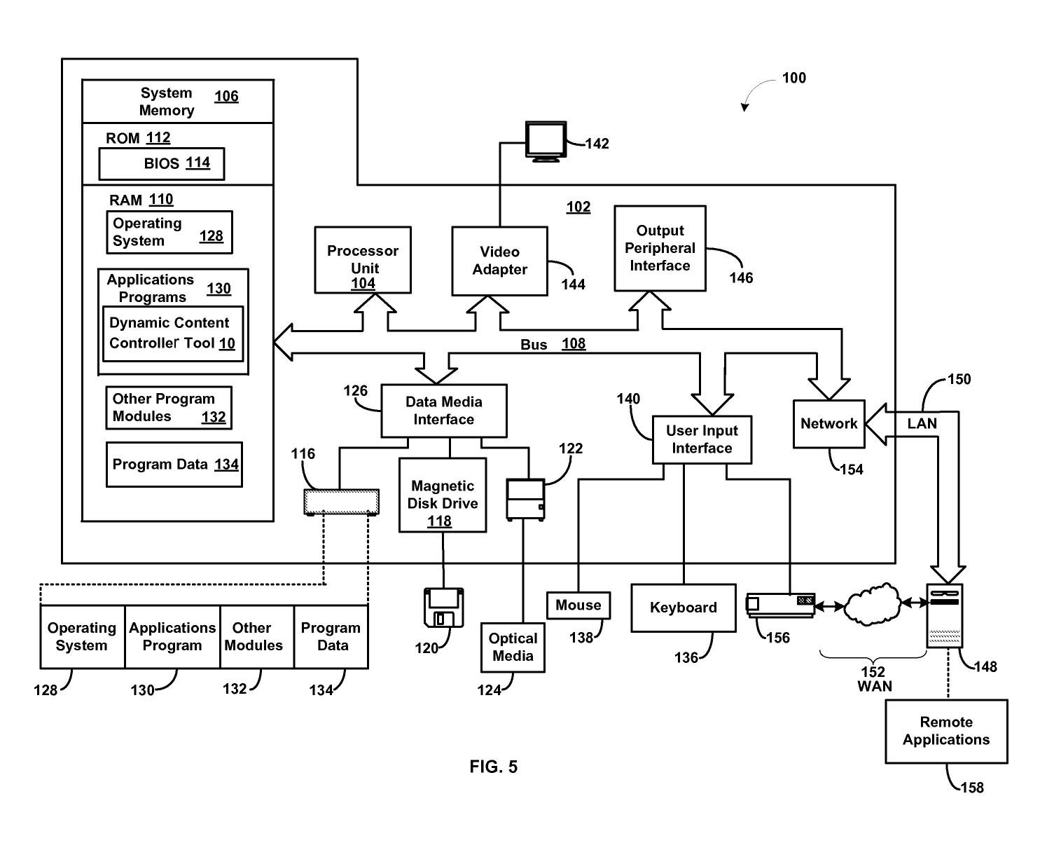

FIG. 5 shows a schematic of an exemplary computing environment 100 in which the dynamic content controller tool 10 shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 5.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers (PCs), server computers, thin clients, thick clients, hand-held or laptop devices, multiprocessor systems, microprocessor-based systems, set-top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 5, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 5, the system memory 106 includes computer readable media in the form of volatile memory, such as random access memory (RAM) 110, and/or non-volatile memory, such as read only memory (ROM) 112. A basic input/output system (BIOS) 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 5 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130 (e.g., dynamic content controller tool 10), other program modules 132, and program data 134.

Each of the operating system 128, one or more application programs 130 other program modules 132, and program data 134 or some combination thereof, may include an implementation of the dynamic content controller tool 10 of FIG. 1. Specifically, each may include an implementation of the dynamic content controller tool 10 which: (a) continuously monitors the meeting including the agenda and presentations for the occurrence of conditions that relate to one of a plurality of trigger event parameters; (b) determines whether a trigger event has occurred during the meeting; and (c) dynamically controls the content and flow of the agenda and presentations when a trigger event has occurred.

A user may enter commands and information into the computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processing unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 5 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 5 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media”and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this disclosure, an approach for providing dynamic control of an electronic meeting. While the disclosure has been particularly shown and described in conjunction with a preferred embodiment thereof, it will be appreciated that variations and modifications can be effected by a person of ordinary skill in the art without departing from the scope of the disclosure.

In another embodiment, this disclosure provides a business method that performs the process steps of the invention on a subscription, advertising, and/or fee basis. That is, a service provider could offer to provide dynamic control of an electronic meeting within a computer system. In this case, the service provider can create, deploy, maintain, support, etc., a dynamic content controller tool, such as tool 10 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, this disclosure provides a method for using a dynamic content controller tool within a computer system to control the content and flow of a meeting including an agenda set for the meeting and presentations scheduled for the meeting. In this case, a dynamic content controller tool, such as tool 10 (FIG. 1), can be provided and one or more systems for performing the process steps of the disclosure can be obtained and deployed to the framework. To this extent, the deployment of a system can comprise one or more of (1) installing program code on a computing device, such as a computer system, from a computer-readable medium; (2) adding one or more computing devices to the framework; and (3) incorporating and/or modifying one or more existing systems of the framework to enable the framework to perform the process steps of the invention.

What is claimed is:

1. A method for dynamically controlling content and flow of a meeting including an agenda set for the meeting and presentations scheduled for the meeting, comprising:
continuously monitoring the meeting including the agenda and presentations for the occurrence of conditions that relate to one of a plurality of trigger event parameters;
determining whether a trigger event has occurred during the meeting; and
dynamically controlling the content and flow of the agenda and presentations when a trigger event has occurred.

2. The method according to claim 1, wherein the plurality of event trigger parameters comprise attendance, time allotted and expended for agenda items and presentations and priority of content set for discussion in the meeting.

3. The method according to claim 1, wherein the determining of a trigger event comprises applying a plurality of predetermined content event trigger rules to monitored conditions and ascertaining whether a condition has been satisfied to warrant applying one or more of the plurality of predetermined content event trigger rules.

4. The method according to claim 1, wherein the dynamically controlling of the content and flow of the agenda and presentations comprises imposing a change to material set forth in the content that is in accordance with the predetermined content event trigger rules.

5. The method according to claim 1, further comprises providing visual indicators to attendees of the meeting that are indicative of time expended and allotted for agenda items and presentations.

6. A dynamic content controller tool for use in a computer system that manages a meeting including an agenda set for the meeting and presentations scheduled for the meeting, comprising:
a trigger event rules repository configured to store a plurality of predetermined trigger rules;
a monitoring system configured to continuously monitor the meeting including the agenda and presentations for conditions set forth in the plurality of predetermined trigger rules, the monitoring system comprising logic that compares observed conditions to the plurality of predetermined trigger rules in the trigger event rules repository; and
a dynamic content controller configured to receive notification from the monitoring system when a trigger event has occurred and impose a change to the content of the agenda and presentation that is in accordance with specifications set in the plurality of predetermined trigger rules.

7. The tool according to claim 6, wherein the monitoring system monitors for conditions that relate to one of a plurality of event trigger parameters, wherein the plurality of event trigger parameters comprise attendance, time allotted and expended for agenda items and presentations and priority of content set for discussion in the meeting.

8. The tool according to claim 6, further comprises a visual indicator component configured to generate visual indicators to attendees of the meeting that are indicative of time expended and allotted for agenda items and presentations.

9. A system for managing content and flow of a meeting including an agenda set for the meeting and presentations scheduled for the meeting, comprising:
an electronic meeting space configured to display contents of the agenda and presentation during the meeting;
trigger event rules repository configured to store a plurality of predetermined trigger rules;
a monitoring system configured to continuously monitor the meeting displayed on the electronic meeting space for conditions set forth in the plurality of predetermined trigger rules, the monitoring system comprising logic that compares observed conditions to the plurality of predetermined trigger rules in the trigger event rules repository;
a dynamic content controller configured to receive notification from the monitoring system when a trigger event has occurred and impose a change to the content of the agenda and presentation that is in accordance with specifications set in the plurality of predetermined trigger rules; and
a visual indicator component configured to generate visual indicators to the electronic meeting space, wherein the visual indicators are indicative of time expended and allotted for agenda items and presentations.

10. The system according to claim 9, wherein the monitoring system monitors for conditions that relate to one of a plurality of event trigger parameters, wherein the plurality of event trigger parameters comprise attendance, time allotted and expended for agenda items and presentations and priority of content set for discussion in the meeting.

11. A computer-readable medium storing computer instructions for dynamically controlling content and flow of a meeting including an agenda set for the meeting and presentations scheduled for the meeting occurring within a computer system, the computer instructions comprising:
continuously monitoring the meeting including the agenda and presentations for the occurrence of conditions that relate to one of a plurality of trigger event parameters;
determining whether a trigger event has occurred during the meeting; and
dynamically controlling the content and flow of the agenda and presentations when a trigger event has occurred.

12. The computer-readable medium according to claim 11, wherein the plurality of event trigger parameters comprise attendance, time allotted and expended for agenda items and presentations and priority of content set for discussion in the meeting.

13. The computer-readable medium according to claim 11, wherein the determining of a trigger event comprises instructions for applying a plurality of predetermined content event trigger rules to monitored conditions and ascertaining whether a condition has been satisfied to warrant applying one or more of the plurality of predetermined content event trigger rules.

14. The computer-readable medium according to claim 11, wherein the dynamically controlling of the content and flow of the agenda and presentations comprises instructions for imposing a change to material set forth in the content that is in accordance with the predetermined content event trigger rules.

15. The computer-readable medium according to claim 11, further comprises instructions for providing visual indicators to attendees of the meeting that are indicative of time expended and allotted for agenda items and presentations.
